(19) United States
(12) Patent Application Publication
(10) Pub. No.: US 2010/0023966 A1
(43) Pub. Date: Jan. 28, 2010

(54) SYSTEM AND METHOD FOR CONTEXTUAL ADAPTIVE ADVERTISING

(75) Inventors: Behzad Shahraray, Holmdel, NJ (US); Andrea Basso, Marlboro, NJ (US); Lee Begeja, Gillette, NJ (US); David C. Gibbon, Lincroft, NJ (US); Zhu Liu, Marlboro, NJ (US); Bernard S. Renger, New Providence, NJ (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT&T Labs, Austin, TX (US)

(21) Appl. No.: 12/177,603

(22) Filed: Jul. 22, 2008

(51) Int. Cl. H04N 7/025

(52) U.S. Cl. 725/34

(57) ABSTRACT

Disclosed herein are systems, methods, and computer readable-media for contextual adaptive advertising. The method for contextual adaptive advertising comprises analyzing a video program, selecting at least one advertisement related to the video program and based on a viewer profile, and displaying the at least one advertisement simultaneously with the video program. One aspect of the method includes advertisements that are one or more of audio, text, images, or video and are displayed in a different modality, in a different location, or on a different device. Contextual adaptive advertisements may be displayed in a partially transparent manner over the video program. Contextual adaptive advertisements may be streamed, stored in advance, or a combination of both. The space and time for advertisements may also be auctioned to interested parties based on a number of parameters.

### BACKGROUND OF THE INVENTION

1. Field of the Invention

The present invention relates to advertising and more specifically to individualized advertising.

2. Introduction

Traditional video advertising approaches are very rough and course-grained. A television broadcast advertisement is targeted at thousands, if not millions, of viewers. No way exists to determine what, if anything, viewers have in common, except that they are watching the same television show. Certain categories of users may be inferred from the television programming content and viewing habits but advertisers do not know much about each viewer individually. This lack of knowledge leads to many wasted dollars, minutes, and opportunities in advertising. One approach to categorize users is the Nielsen ratings system but Nielsen ratings are conducted as a survey of random viewers. Viewing habits of a small group are extrapolated to estimate viewing habits of the larger group.

The dollars wasted to purchase the advertising time are lost. The opportunity to deliver a narrowly targeted advertisement is weak in television advertising. Some examples of advertising waste include showing a man an advertisement for feminine hygiene products or showing a young child an advertisement for a pickup truck. While some marketing specialists argue that even these advertisements have some value, for example, in reinforcing a brand, showing an ad to a person incapable of purchasing or uninterested in purchasing the advertised product is not as productive as it could be if shown to a more interested person.

One approach to resolve this issue on the Internet is to force a user to view an advertisement before playing a video clip. This approach does not address the problem of overly broad ads and it does not solve a problem for television-based ads. The typical web video advertisement prior to a video clip is sponsor-selected or is selected from one of a small library of advertisements rather than being tailored specifically to the user.

Some special interest television shows, such as those focusing on motorcycle enthusiasts, provide for some level of information about the viewer. Such a motorcycle show does not let an advertiser know if a particular viewer is interested in Harley-Davidson or Yamaha motorcycles. Consequently, even “targeted” advertisements based on a special interest television show may waste resources conveying an advertisement to someone who is uninterested in the product or service.

Accordingly, what is needed in the art is a way to avoid advertising waste through more narrowly targeted video advertising to individuals rather than the traditional, overly broad approach to advertising.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods and computer-readable media for contextual adaptive advertising by analyzing a video program, selecting at least one advertisement related to the video program and based on a viewer profile, and displaying the at least one advertisement simultaneously with the video program.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a method embodiment for contextual adaptive advertising;

FIG. 3 illustrates an exemplary system embodiment for contextual adaptive advertising;

FIG. 4A illustrates delivery of contextual adaptive advertising on a widescreen television in a “U” bar;

FIG. 4B illustrates delivery of contextual adaptive advertising on a widescreen television in side bars;

FIG. 4C illustrates delivery of contextual adaptive advertising on a widescreen television in an overlaid side bar; and

FIG. 4D illustrates delivery of contextual adaptive advertising on a non-widescreen television in an L Bar.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

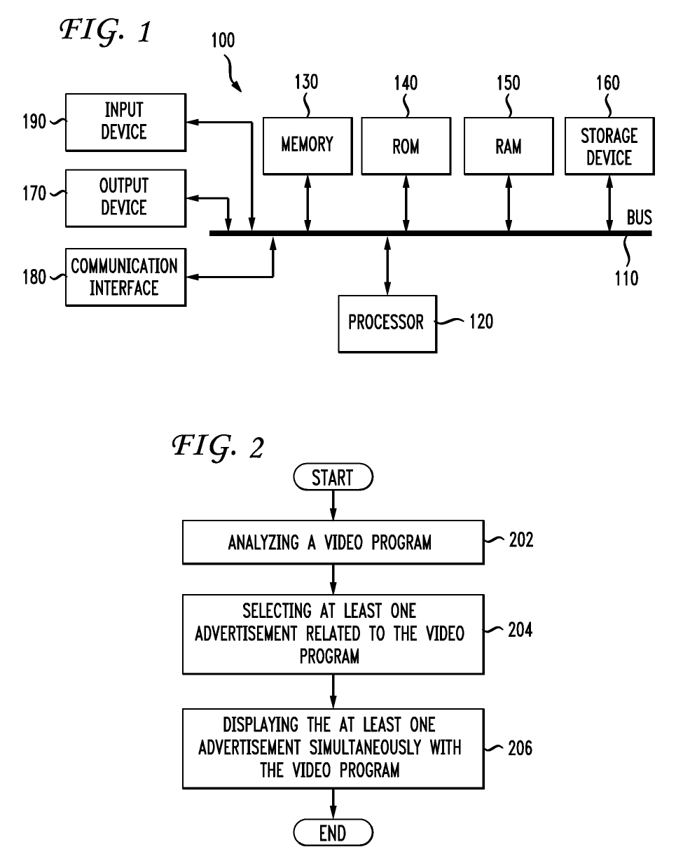

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, and so forth. The input may be used by the user to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

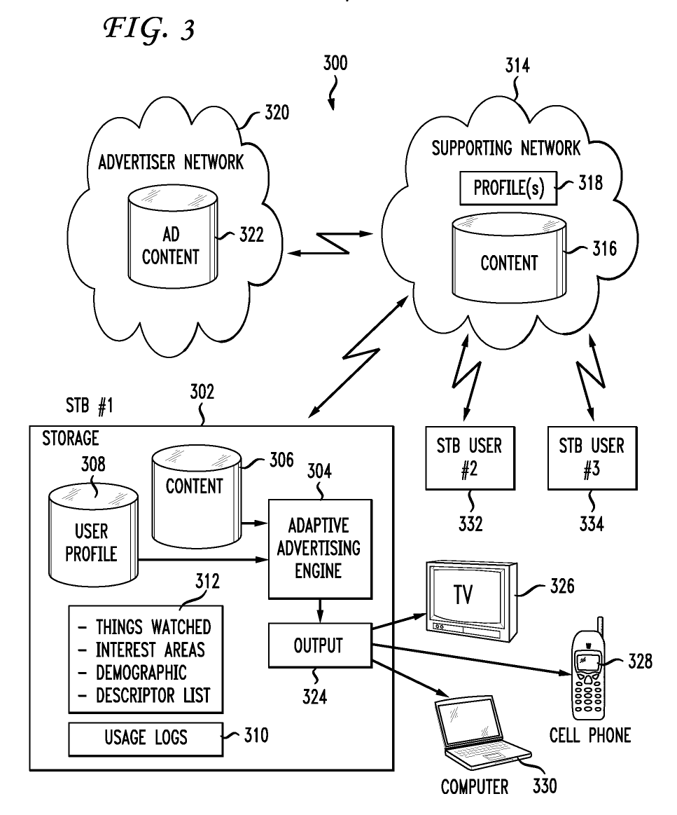

FIG. 2 illustrates a method embodiment for contextual adaptive advertising. First, the method analyzes a video program 202. The analysis of the video program can be accomplished in a number of ways. For example, the analysis can include audio, video, textual information extraction, and/or metadata. Any combination of features of the video program may be analyzed. The video program can include a cable television signal, television over IP (IPTV), television signals recorded with a digital video recorder, DVDs, etc. The program may be analyzed on a segment by request basis. Thus, ads presented during one portion may differ from those presented at a different portion. For example, one segment of a program may have a certain tempo to the action. Movies have slow parts and fast parts. In one aspect, the ad chosen may be consistent with the tempo of the segment of the program during which the ad is shown. Thus, one can avoid disrupting the tempo of a program by presenting an appropriate ad. Second, the method selects at least one advertisement related to the video program and based on a viewer or user profile 204. The user profile may include a variety of parameters or details such as key words, key phrases, topics selected or associated with the user, and so forth. The advertisement can be one or more of audio, text, pictures, or video and is displayed in a different modality, in a different location, or on a different device. In one aspect, a television show is the video program and a related advertisement is sent not to a television but to a viewer's cellular phone as a text message, photo, or video message. In another aspect, if the viewer profile indicates that the viewer often browses the internet while watching television, the advertisement is sent to the user as an email message. Not all viewers will use another gadget while watching television, so in one aspect the video program is a cable television broadcast and the cable set-top box or a network element selects advertisements and plays them on the side of the video program or even overlays the advertisements in a manner similar to picture-in-picture. The overlaid advertisements in this aspect can be opaque, translucent, or partially transparent.

In order to select an advertisement catered to the viewer and related to the video program, input may be drawn from many resources. Some resources include a user profile, usage logs, user demographics, advertiser preferences, time of day, or type of video program. Other sources are contemplated as well. Usage logs and user profiles may include information intersecting across media and devices. In this aspect, usage logs includes web sites visited, emails written, television shows watched (partially or completely), times of day television is watched, recent purchases online or with a credit card, individuals calls or text messages and the content of those communications, television shows recorded, movie viewing history, etc. Aspects of user profiles include not only the user's preferences and personal information, but also limited preferences and personal information about family members and close friends. This aspect allows for birthdays and gift preferences, upcoming holidays that the user observes (Christmas, Rosh Hashanah, and so forth).

A cable television provider, for example, can offer a user the option to set one or more of the frequency, type, and delivery method of advertisements. In addition, the user can specify the quality and characteristics of the image, audio, or video content in the ads. For example, the size of the ad can be specified by the user. Often these options are related to fees. In this aspect, the frequency of fees is directly related to the fees paid by a consumer. The consumer may get a discount on television programming in exchange for viewing contextually adaptive advertisements on every show. The discounts offered by the cable television provider may be graduated, allowing for varying frequency of contextual adaptive advertising. In this aspect, the user can pay an additional fee to enjoy a favorite television show without contextual adaptive advertising. The fee can be paid in a monthly bill or as a micro-transaction, such as via a credit card or direct billing an account. In another aspect, parents may be concerned about the type of advertisements and specify that no ads of a sexual nature be displayed in their house between 5:00 am and 10:00 pm. Similarly, if a parent is paying for a teenager's cellular phone and the cell phone package only includes limited text messaging, the parent can specify that no contextual adaptive advertisements are distributed to cell phones via text messaging. Cable providers can offer options to consumers depending on cable television package or a la carte.

Contextual adaptive advertisements can include auctions which are also displayed to other users. This aspect of contextual adaptive advertisements is illustrated by a car dealer running a weekend promotion on a truck. The car dealer purchases advertising time targeted at users having certain interests in their profile and having a certain income level. Other information in the profile can include any demographic information such as age, race, religion, gender, marital status, etc. The auction advertisement shows these potentially interested users an ad including real-time information about the auction, such as “Hurry down to ABC Chevrolet or call ABC Chevrolet! Don't miss our auctions on 2009 Chevrolet Tahoes. 18 sold today already and the high bid for the next Tahoe is only $21,400!” Many auction variations exist and the contextual adaptive advertisement can be altered automatically in real time to reflect the actual status of many auction variations.

In one aspect, the contextual adaptive advertisements are streamed, stored in advance, or a combination of both. A set top box or other device analyzes user profiles of frequent viewers and can retrieve a set of advertisements in anticipation of displaying them in the near future. Likewise, commonly displayed advertisements are stored in advance. The set top box or other device can analyze the user profile to determine which of these advertisements achieved a result by influencing the user's behavior. These effective advertisements are stored for future playback or analyzed for commonalities to determine what made them so successful in engaging this particular user. These commonalities are used to retrieve similar contextually adaptive advertisements. In a sub-aspect, the cable provider charges advertisers a premium for advertisements thought to be especially influential on the user.

In another aspect, the selection of an advertisement, its timing for display, etc. can be auctioned off to the most interested party. Thus, companies, as interested parties, may bid for the opportunity to present the advertisement or an advertisement of their own selection to appropriate recipients based on any number of factors. Such an auction for individualized personal ad time may be manually performed or automatically processed.

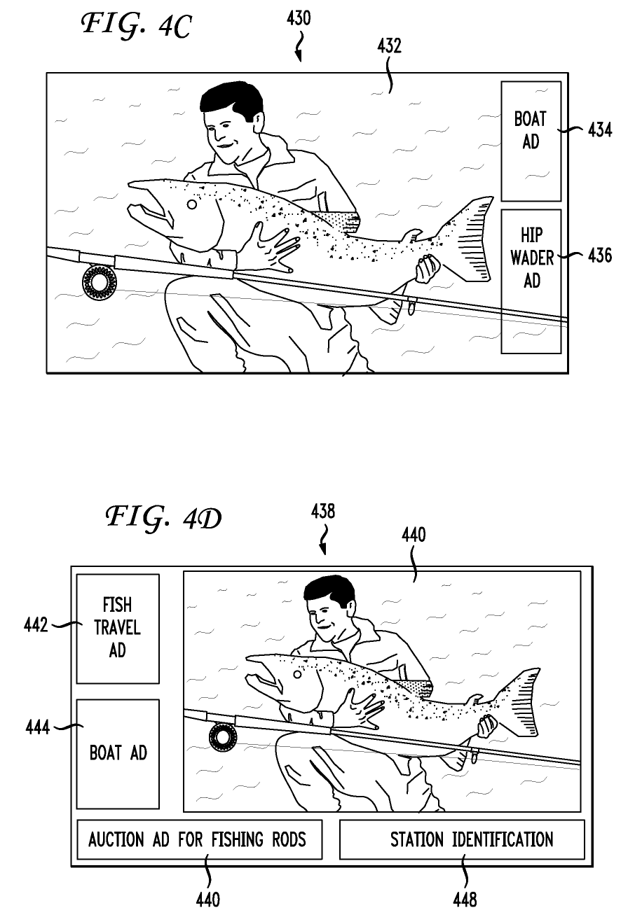

Third, the method displays the at least one advertisement simultaneously with the video program 206. In one aspect of the method, an additional step is taken of changing the video program to an advertisement-related program in response to a user selection. For example, when a user is shown an advertisement on the same screen as the video program, the user is allowed to click on or select the advertisement for more information. While the advertisement-related program is displayed, the original video program is paused and then resumed when the advertisement-related program is terminated. This can be accomplished with a simple digital video recorded (DVR) such as TIVO or ReplayTV. FIGS. 4A, 4B, 4C, and 4D illustrate various ways to display advertisements on the same television screen as the video program.

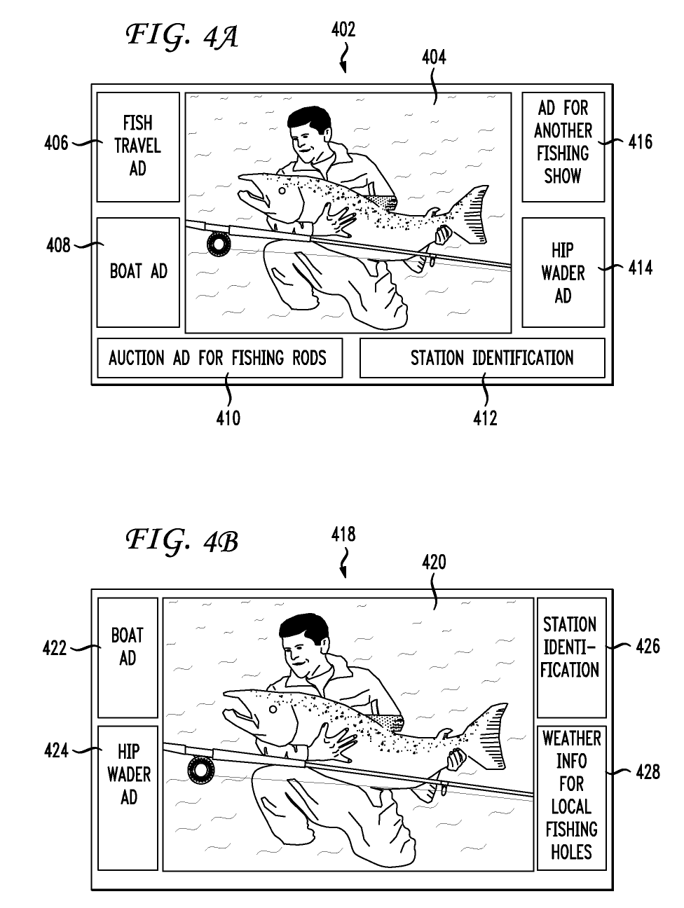

FIG. 3 illustrates an exemplary system embodiment for contextual adaptive advertising 300. In this aspect, a set-top box 302 such as a cable television receiver contains an adaptive advertising engine 304. In the case of a set-top box with an integrated DVR, content 306 can be recorded and stored in the set-top box. A user profile 308 is maintained by analyzing usage logs 310 which record how the user or users interact with the set-top box. Interactions include what shows are watched (partial or complete), when channels are changed, what services are ordered, who is watching, etc. A user profile also incorporates interest areas, demographic information, and descriptor lists.

The set-top box communicates with the supporting network 314. The supporting network is something like a cable television network or a collection of IP-based content delivery mechanisms. The supporting network is an additional source of content 316 such as broadcast video programs or stored videos for on-demand retrieval, like pay-per-view or youtube.com. The supporting network can also store user profiles 318. The user profiles stored in a network may allow for roaming profiles that follow the user regardless of where the user is or what device the user is interacting with or the user profiles may allow for more comprehensive data collection for a more complete picture of what the user may be interested in.

The set-top box or the supporting network analyzes the video program and retrieves ad content 322 for contextual adaptive advertisements from an advertiser network 320. Advertisements are transmitted from the advertiser network through the supporting network to the set-top box. The set-top box can either store them for later retrieval or it can display them immediately to the user via an output 324. The contextual adaptive advertisements can be displayed on a multitude of devices, including the same television 326 as the video program is displayed on, a cellular phone 328, a computer 330, or other devices.

The supporting network can support multiple set-top boxes, as illustrated by set-top boxes for user 2 (332) and user 3 (334). As discussed above, the user profile stored in the supporting network may replace or supplement the user profile in multiple set-top boxes. In this aspect, a viewer watches television at his house and at his mother's house. The user profile follows the viewer between set-top boxes in both locations. So changes and behavior recorded in one location influences the contextual adaptive advertising for that viewer in both locations.

FIG. 4A illustrates delivery of contextual adaptive advertising on a widescreen television 402 in a “U” bar. The television show 404 is shrunk to less than the full size of the television to allow for three sides of the screen to be filled with advertisements or other content in a U bar. Not all slots in the U bar need to be filled at all times. They can be filled only when relevant content is available. In an aspect discussed above, the frequency and type of advertising is influenced by how much a user pays. Advertisements can be entirely eliminated for certain TV shows for a fee or eliminated for all television shows for a fee. One example of this is a user who enjoys Seinfeld and pays a monthly fee to remove all contextual adaptive advertisements from being played during Seinfeld. A usage log continues to gather and store usage information even if contextual adaptive advertisements are not displayed. In this figure, the television show is a fishing show. Related advertising or other content in this figure is a fish travel ad 406 may be even for the same location as the television show, a boat ad 408, an auction for fishing rods 410 as discussed above with real-time updates, station identification 412, a hip-wader ad 414, and an ad for another fishing show 416. These advertisements can be video, image, still text, scrolling ticker of text like on the bottom of CNN, or any combination thereof. Audio associated with the advertisements, if present, can be muted, played quietly over the video program, or played at specific times or events, such as if the user moves a cursor over the advertisement or clicks on the advertisement.

One of the unique properties of this U bar approach is adapting traditional 4:3 aspect television programming for display on a widescreen 16:9 television. FIG. 4B is another approach to adapting 4:3 standard programming to 16:9 widescreen formats. FIG. 4B illustrates delivery of contextual adaptive advertising on a widescreen television 418 in side bars. The television show 420 is shrunk to less than the full size of the television to allow for the two side bars of the screen to be filled with advertisements or other content. Not all slots in the side bars need to be filled at all times. They can be filled only when relevant content is available. In this figure, the television show is a fishing show. Related advertising or other content in this figure is a boat ad 422, a hip-wader ad 424, station identification 426, and weather updates for local fishing holes 428. The station identification and weather updates are examples of non-advertising other content. This content may be provided as a service to the user, at the user's request, or may be used to fill slots in the side bars when suitable advertising is unavailable. These advertisements and other content can be video, image, still text, scrolling ticker of text like on the bottom of CNN, or any combination thereof. Audio associated with the advertisements, if present, can be muted, played quietly over the video program, or played at specific times or events, such as if the user moves a cursor over the advertisement or clicks on the advertisement.

While FIGS. 4A and 4B illustrate adapting traditional 4:3 aspect television programming for display on a widescreen 16:9 television, more and more content is produced in widescreen format and shrinking widescreen movies is not always desirable because it may distort the picture or render a large portion of the screen unused. FIG. 4C illustrates a way to display adaptive contextual advertisements without shrinking the video program. FIG. 4C illustrates delivery of contextual adaptive advertising on a widescreen television 430 in an overlaid side bar. The video program 432 is displayed in its original widescreen aspect which matches the television. Advertisements 434, 436 are displayed over a portion of the video program in an opaque, translucent, or partially transparent manner. The overlaid advertisements can be arranged in any desired positions, but a single side bar is shown in the exemplary illustration. The same types of ads may be shown in overlays as in side bars or U bars. Advertisers may produce several ad designs to optimize for the differences between translucent or partially transparent overlaid ads and ads displayed by themselves in a side bar or U bar.

FIG. 4D illustrates delivery of contextual adaptive advertising on a non-widescreen television 402 in an L Bar. The television show 440 is shrunk to less than the full size of the television to allow for two sides of the screen to be filled with advertisements or other content in an L bar. Not all slots in the L bar need to be filled at all times. They can be filled only when relevant content is available. Related advertising or other content in this figure is a fish travel ad 442 may be even for the same location as the television show, a boat ad 444, an auction for fishing rods 446 as discussed above with real time updates, and station identification 448. These advertisements can be video, image, still text, scrolling ticker of text like on the bottom of CNN, or any combination thereof. Audio associated with the advertisements, if present, can be muted, played quietly over the video program, or played at specific times or events, such as if the user moves a cursor over the advertisement or clicks on the advertisement.

In another aspect of this disclosure, the advertising space or time is auctioned, in real time, to interested parties. For example, if a movie about car racing is scheduled for viewing and the profile of the viewer indicates an interest in automobiles, the system, either automatically or manually, presents an auction for the advertising for this particular viewer of this particular movie. Examples of interested parties include local car dealers or major car manufacturers such as Ford or Acura. The auction for advertising time is provided with information about the viewer so that the advertisers can assess how much to bid for the time. The baseline bid may be set as the value of the ads that generally run to establish the auction equivalent of a reserve.

The disclosed aspect of implementing auctions may create an automated mart for such auctions for advertising time that would serve the same purpose as E-bay®. Buyers and sellers interact via such an auction. The auctions are generally automated because it would be extremely difficult for a human to keep up with the millions of auction possibilities that would be created dynamically minute by minute.

A viewer can interact with or select an advertisement to view. Such viewer interaction can be accomplished with a standard wireless or wired remote control. Enhanced remote controls with improved pointing technology, such as a Nintendo Wii Remote or a presentation remote with a laser pointer and a mouse, may be used as well.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the processes described herein may have application in cable or over-the-air television broadcasts, streaming video online, DVD playback, etc. Further, functionality disclosed herein may be processed locally such as on a set-top box or in a network element or a combination of both. Thus, a particular location of where a particular process occurs or is practiced is flexibly under the principles disclosed herein. Those skilled in the art will readily recognize various modifications and changes that may be made to the present invention without following the example embodiments and applications illustrated and described herein, and without departing from the true spirit and scope of the present invention.

We claim:

1. A method of contextual adaptive advertising, the method comprising:
analyzing a video program;
selecting at least one advertisement related to the video program and based on a viewer profile; and
displaying the at least one advertisement simultaneously with the video program.

2. The method of claim 1, wherein the at least one advertisement is one or more of audio, text, pictures, or video and is displayed in a different modality, in a different location, or on a different device.

3. The method of claim 2, wherein the at least one advertisement is displayed in a partially transparent manner over the video program.

4. The method of claim 1, wherein selecting at least one advertisement related to the video program is based on one or more of a user profile, usage logs, user demographics, advertiser preferences, time of day, or type of video program.

5. The method of claim 1, the method further comprising:
changing the video program to an advertisement-related program in response to a user selection.

6. The method of claim 5, wherein the video program is paused while the advertisement-related program is displayed and wherein the video program is resumed thereafter.

7. The method of claim 1, wherein a user sets one or more of the frequency, type, and delivery method of the at least one advertisement.

8. The method of claim 1, wherein selecting the at least one advertisement further comprises auctioning to interested parties individual personalized ad time for the at least one advertisement.

9. The method of claim 1, wherein the at least one advertisement is streamed, stored in advance, or a combination of both.

10. A system for contextual adaptive advertising, the system comprising:
a module configured to analyze a video program;
a module configured to select at least one advertisement related to the video program and based on a viewer profile; and
a module configured to display the at least one advertisement simultaneously with the video program.

11. The system of claim 10, wherein the at least one advertisement is one or more of audio, text, pictures, or video and is displayed in a different modality, in a different location, or on a different device.

12. The system of claim 11, wherein the at least one advertisement is displayed in a partially transparent manner over the video program.

13. The system of claim 10, wherein selecting at least one advertisement related to the video program is based on one or more of a user profile, usage logs, user demographics, advertiser preferences, time of day, or type of video program.

14. The system of claim 10, the system further comprising:
a module configured to change the video program to an advertisement-related program in response to a user selection.

15. The system of claim 14, wherein the video program is paused while the advertisement-related program is displayed and wherein the video program is resumed thereafter.

16. The system of claim 10, wherein a user sets one or more of the frequency, type, and delivery method of the at least one advertisement.

17. The system of claim 10, wherein the module configured to select further selects the at least one advertisement by auctioning to interested parties individual personalized ad time for the at least one advertisement.

18. The system of claim 10, wherein the at least one advertisement is streamed, stored in advance, or a combination of both.

19. A computer-readable medium storing a computer program having instructions for contextual adaptive advertising, the instructions comprising:
analyzing a video program;
selecting at least one advertisement related to the video program and based on a viewer profile; and
displaying the at least one advertisement simultaneously with the video program.

20. The computer-readable medium of claim 19, wherein the at least one advertisement is one or more of audio, text, pictures, or video and is displayed in a different modality, in a different location, or on a different device.

21. The computer-readable medium of claim 20, wherein the at least one advertisement is displayed in a partially transparent manner over the video program.

22. The computer-readable medium of claim 19, wherein selecting at least one advertisement related to the video program is based on one or more of a user profile, usage logs, user demographics, advertiser preferences, time of day, or type of video program.

23. The computer-readable medium of claim 19, the instructions further comprising:
changing the video program to an advertisement-related program in response to a user selection.

24. The computer-readable medium of claim 23, wherein the video program is paused while the advertisement-related program is displayed and wherein the video program is resumed thereafter.

25. The computer-readable medium of claim 19, wherein a user sets one or more of the frequency, type, and delivery method of the at least one advertisement.

26. The computer-readable medium of claim 19, wherein selecting the at least one advertisement further comprises auctioning to interested parties individual personalized ad time for the at least one advertisement.

27. The computer-readable medium of claim 19, wherein the at least one advertisement is streamed, stored in advance, or a combination of both.
